(19) United States
(12) Patent Application Publication
(10) Pub. No.: US 2007/0011207 A1
(43) Pub. Date: Jan. 11, 2007

(54) Method and system for integrating file system events into a relational database

(76) Inventor: Prasad R. Vishnubhotla, Round Rock, TX (US)

Correspondence Address: Greg Goshorn, P.C., 9600 Escarpment, auite 745-9, AUSTIN, TX, 78749, US

(21) Appl. No.: 11/175,061

(22) Filed: Jul. 5, 2005

(51) Int. Cl. G06F 17/30

(52) U.S. Cl. 707/200

(57) ABSTRACT

Provided is a method of integrating events such as creation, modification and deletion associated with computer files into a database management system (DBMS) or relational DBMS (RDBMS). Once a file associated with a RDBMS is created, updated or deleted, the RDBMS is notified of the event so that a trigger corresponding to the event and the file can be executed. A file system callback mechanisms associated with asynchronous and non-blocking input/output (I/O) functions communicates the completion of file creation, deletion and update operations to a RDBMS. The RDBMS recognizes the communication and fires an appropriate database trigger or triggers.

### TECHNICAL FIELD

The present invention relates generally to data management systems (DBMSs) and, more specifically, to a method of integrating computer data files with a DBMS.

### BACKGROUND OF THE INVENTION

The development of computers and electronic data storage mechanisms have enabled users to maintain, organize and manipulate vast amounts of information. Many methods have been developed to facilitate the storage and organization aspects of information processing. Originally, data was stored on cards but was soon moved to electronic storage media including tapes and removeable storage disks. More recently, the development of networking and cheap electronic memory have enabled information to be conveniently stored within computer systems themselves.

Within computer memory, information was originally stored as simple or “flat,” files. Eventually, more organized structures were developed, one of which was the database management system (DBMS) and, more specifically, the relational DBMS (RDBMS). Within RDBMSs, relational tables are the primary means of data storage and structured query language (SQL) is the primary means of accessing and manipulating the data. Despite the advantages of RDBMSs, much data is still stored within simple file systems.

Techniques that have been provided to integrate standard files into a RDBMSs include the following:
Import and export of standard files to and from relational files via record-by-record data movement;
Load utilities that support bulk movement of data between standard files and relational tables; and
Data link technology, which is now part of the SQL standard, that enables standard file system files to be represented in relational tables as links.

Another issue in RDBMSs is the need to initiate actions upon the occurrence of particular events. Most RDBMSs provide “triggers,” which are special, event-driver procedures that are stored and managed by the RDBMS. In short, a RDBMS executes, or “fires,” a trigger in response to a data modification in an associated table. A trigger that is fired may cause another data modification that causes one or more other triggers to fire. This is referred to as “nested” triggers.

One feature that is missing from the current state-of-art in data storage and RDBMS technology is the integration of file events into DBMSs and RDBMSs. Such file events include, but are not limited to, file creation, file update and file deletion. What is needed is a way to integrate file events into RDBMSs in a manner that is timely, reliable and automatic.

### SUMMARY OF THE INVENTION

Provided is a method of integrating file events such as, but not limited to, file creation, file update and file deletion into a relational database management system (RDBMS). Basically, file events are automatically introduced into a RDBMS as database triggers.

Once a file associated with a particular RDBMS is created, updated or deleted the RDBMS is notified of the event via a special database table so that a corresponding trigger can be executed. For example, a file containing information that a first database needs to import may be created by a second database. Often, the quickest way to transfer data between two databases is to have one database import a file that was created by a second database. A file to be loaded may also be created by a non-database application or sent from a remote site and stored in the local file system. Often, it is important to load information from a newly created file into the RDBMS as soon as the file is created. Currently, low-level programming employing operating system and scripting facilities must be implemented, typically polling a file system. Once a polling process detects that a file has been created, a RDBMS can be notified to execute a load module. The scope of a database programmer's duties may not include this type of programming.

In a similar fashion, a RDBMS may need to update tables when a file is updated. For example, an old file may have new records appended or old records replaced. Again, the necessary programming may be outside the scope of a database programmer's responsibilities. In addition, when a file is deleted, programs such as one that loads the file may need to be closed or removed from a list of scheduled tasks. Of course, file creation, modification and deletion may each include multiple tasks to be performed to keep a corresponding database current.

The claimed subject matter employs file system callback mechanisms associated with asynchronous and non-blocking input/output (I/O) functions to communicate the completion of file creation, deletion and update operations to a RDBMS. The callbacks are then employed to fire database triggers.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE DRAWINGS

A better understanding of the present invention can be obtained when the following detailed description of the disclosed embodiments is considered in conjunction with the following drawings.

FIG. 1 is a block diagram of a computing architecture, including a relational database management system (RDBMS), that supports the claimed subject matter.

FIG. 2 is an exemplary File_Events table of the RDBMS of FIG. 1 employed to implement the claimed subject matter.

FIG. 3 is a flowchart of a Setup process that configures the architecture and RDBMS of FIG. 1 according to the claimed subject matter.

FIG. 4 is a flowchart of an Interrupt Service Routine (ISR) process that supports the claimed subject matter.

FIG. 5 is a flowchart of a Database (DB) Operation process that supports the claimed subject matter.

FIG. 6 is an illustration of three process fragments associated with DB Operation process of FIG. 5.

### DETAILED DESCRIPTION OF THE FIGURES

Although described with particular reference to a relational database management system (RDBMS), the claimed subject matter can be implemented in any database architecture that provides a mechanism for the asynchronous handling of events. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for integrating file events such as, but not limited to, file creation, file update and file deletion into a relational database management system (RDBMS). The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

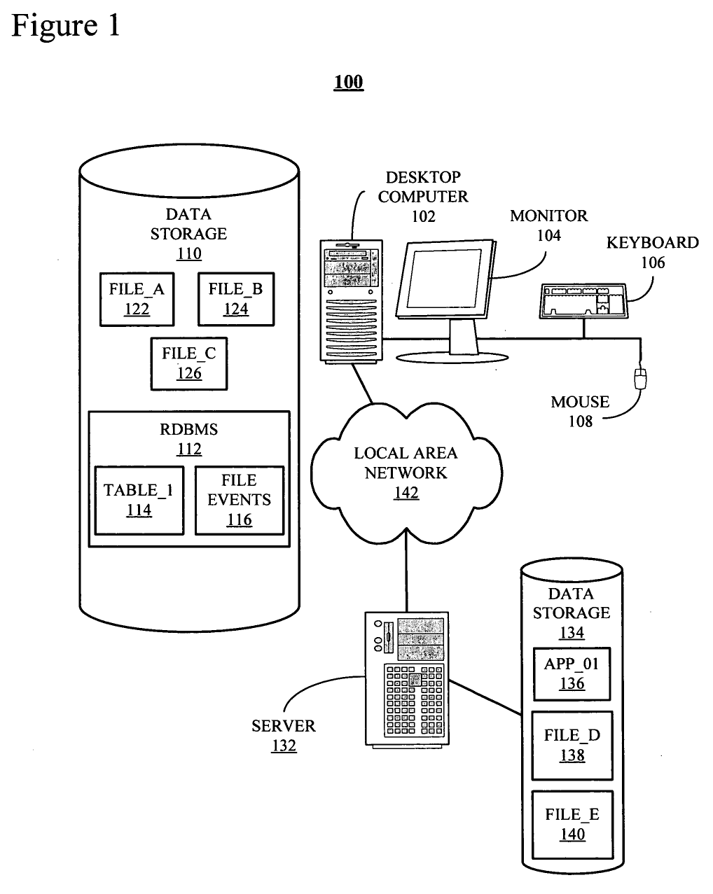

Turning now to the figures, FIG. 1 is a block diagram of an exemplary computing system architecture 100 that incorporates the claimed subject matter. A desktop computer 102 includes a monitor 104, a keyboard 106 and a mouse 108, which together facilitate human interaction with computer 102. Attached to computer 102 is a data storage component 110, which may either be incorporated into computer 102 i.e. an internal device, or attached externally to computer 102 by means of various, commonly available connection devices such as but not limited to, a universal serial bus (USB) port (not shown).

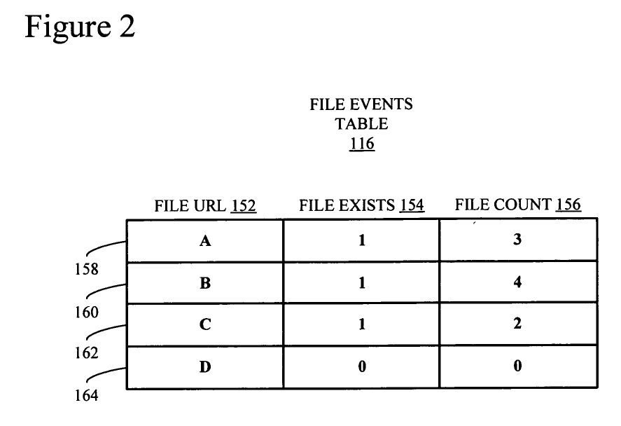

Data storage 110 stores a relational database management system 112, which includes an exemplary table, Table_1 114, and a table specifically for implementing the claimed subject matter, a File_Events table 116. File_Events table 116 is illustrated in more detail below in conjunction with FIG. 2. Typically, a database includes dozens or even hundreds of files but, for the sake of simplicity, only two (2) files are illustrated.

In this example, data storage 110 stores exemplary files, File_A 122, File_B 124 and File_C 126. Files 122, 124 and 126 are used as examples in the following description. It should be understood that a typical computer system has multiple application files, data files and configuration files.

A server computer 132 is attached to a data storage component 134, which, like data storage 110, may be an internal or external device. In this example, data storage 134 stores an application file, app_01 136 and two exemplary data files, a File_D 138 and a File_E 140. App_01 136 and data files 138 and 140 are used as examples in the following description. As mentioned above, a typical computer system has multiple application files, data and configuration and data files.

Server 132 and computer 102 are communicatively coupled via a local area network (LAN) 142. LAN 142 is used as an example only. Those with skill in the computing and communication arts should appreciate that there are many techniques for providing communication between computer 102 and server 132. For example, computer 102 and server 132 may communicate over a dedicated connection or the Internet rather than LAN 142.

FIG. 2 illustrates File_Events table 116 of RDBMS 112, both introduced in FIG. 1, in greater detail. Table 116 has three columns a “File Universal Resource Locator (URL)” column 152, a “File Exists” column 154 and a “File Count” column 156. File URL column stores information that identifies files stored, in this example, on data storage 110 that are relevant to tables such as table_1 114 of RDBMS 112. A first row 158 is associated with File_A 122 (FIG. 1) as shown by the letter ‘A’ stored in File URL column 152. Of course, that data shown in column 152 is for illustrative purposes only; actual data that identifies a specific file on data storage 110 would uniquely identify a file such as with a fully qualified directory path and file name.

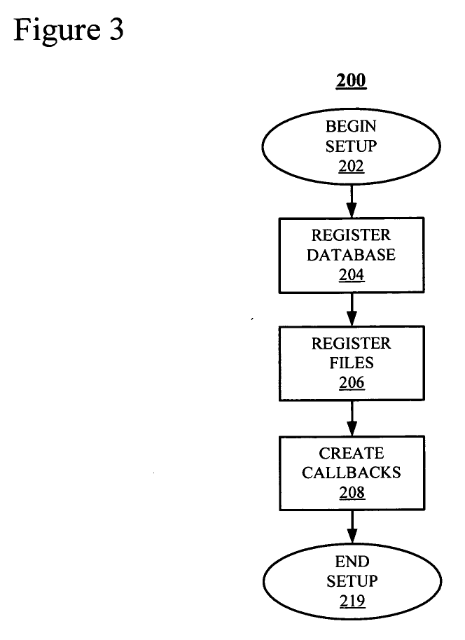

A second row 160 of table 116 corresponds to file_B 124 (FIG. 1); a third row 162 of table 116 corresponds to file_C 126 (FIG. 1) and a fourth row 164 of table 116 corresponds to File_D 138 (FIG. 1), which at the time of this example is on data storage 134 (FIG. 1) and not on data storage 110. The significance of the data stored in File Exists column 154 and File Count column 156 is explained in more detail below in conjunction with FIGS. 3-6.

FIG. 3 is a flowchart of a Setup process 200 for configuring architecture 100 and RDBMS 112 of FIG. 1 according to the claimed subject matter. Process 200 starts in a “Begin Setup” block 202 and control proceeds immediately to a “Register Database” block 204. During block 204, the database that is implementing the claimed subject matter, which in this example is RDBMS 112, notifies, or registers, with the operating system (OS) (not shown) of computer 102 (FIG. 1). Examples of OSs that may implement the disclosed techniques include, but are not limited to, Windows, published by the Microsoft Corporation of Redmond, Wash., Unix and Linux. The exact type of OS is not important to the spirit of the invention.

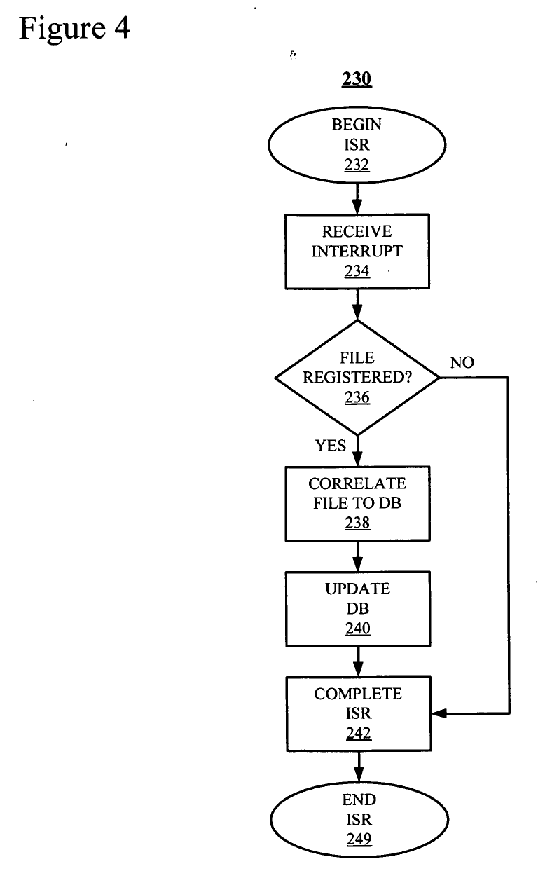

Ideally, the file system of the OS recognizes and can access File_Events table 116 (FIGS. 1 and 2). When RDBMS 112 registers with the OS, the OS is informed of the existence and location of File_Events table 116 so the OS can insert relevant information relating to file access into File_Events table 116. During a “Register Files” block 206, RDBMS 112 provides the OS with a list of files that need to be monitored for file access activity. During a “Create Callbacks” block 208, process 200 installs interrupt service routines (ISRs) that receive asynchronous interrupts from file access activity and analyze the file activity for actions that affect the files registered during block 206. Finally, during an “End Setup” block 219, process 200 is complete and the OS of computer 102 is ready to monitor the files identified during block 206 and notify the databases registered during block 204 when a relevant file access had occurred. The operation of the file monitoring ISRs that has been setup by process 200 is explained in more detail below in conjunction with FIG. 4.

FIG. 4 is a flowchart of a callback or, ISR, process 230 that supports the claimed subject matter. ISR process 230 is installed in the OS of computer 102 (FIG. 1) during Create Callbacks block 208 (FIG. 3). Process 230 starts in a “Begin IRS” block 232 during which the OS has received an interrupt associated with an access of the file system. Control proceeds immediately to a “Receive Interrupt” block 234 during which the callback generated by a file access is received by the OS. During a “File Registered?” block 236, process 230 determines whether or not the callback or interrupt received during block 234 corresponds to a file registered during Register Files block 206 (FIG. 3). If not, control proceeds to a “Complete ISR” block 242 during which the procedures typically associated with a file access ISR are executed.

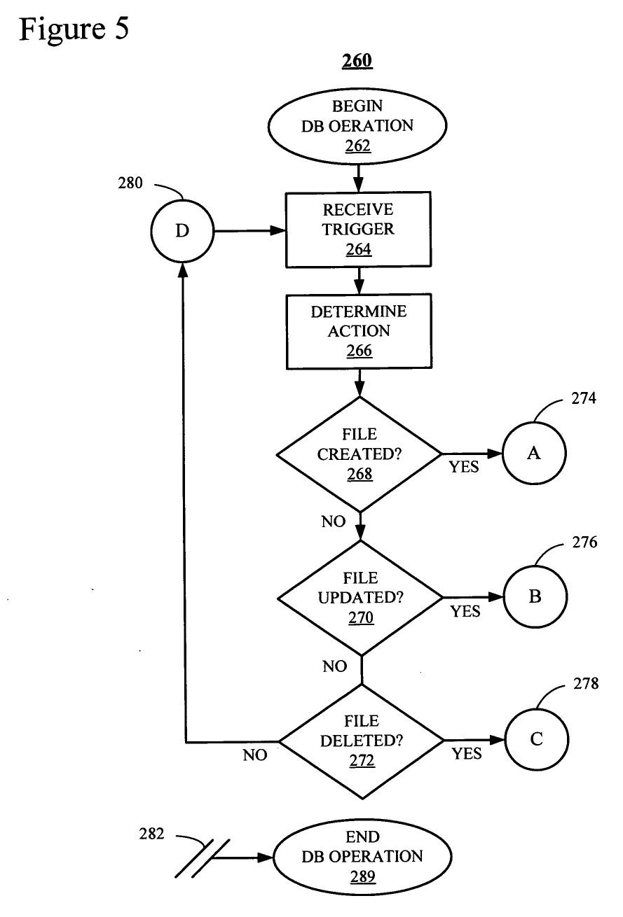

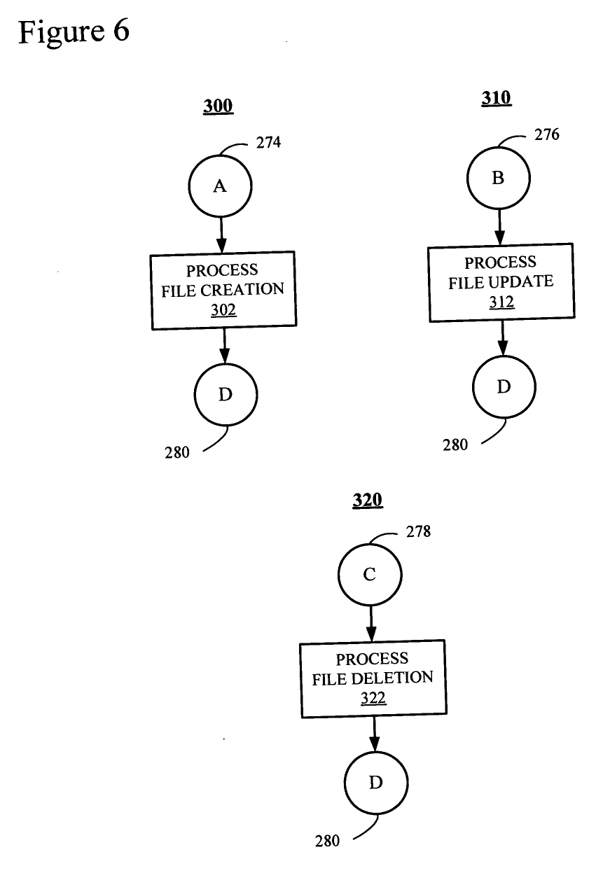

If during block 236, process 230 determines that the file associated with the interrupt received during block 234 was registered during block 206, control proceeds to a “Correlate File to Database (DB)” block 238. During block 238, process 230 correlates the file associated with the interrupt received during block 234 with the corresponding database registered during Register Database block 204 (FIG. 3), which in this example is RDBMS 112 (FIG. 1). Control then proceeds to an “Update DB” block 242 during which process 230 updates information in File_Events table 116. In the alternative, rather than access File_Events table 116 directly, process 230 transmits a message containing file access information to RDBMS 112 and RDBMS 112 is responsible for updating table 116. The update process is explained in more detail below in conjunction with FIGS. 5 and 6. Control proceeds to Complete ISR block 242 during which, as explained above, the normal processing of the IRS is executed. Finally, process 230 proceeds to an “End ISR” block 249 in which process 230 is complete.

FIG. 5 is a flowchart of a “DB Operation” process 260 executed, in this example, by RDMS 112 of FIG. 1. Process 260 starts in a “Begin DB Operation” block 262 and proceeds immediately to a “Receive Trigger” block 264. During block 264, process 260 waits for a trigger to occur. RDBMS 112 is programmed to generate a trigger whenever a change has been made to File_Events table 116. In this example, table 116 was updated during Update DB block 240 (FIG. 4) so control proceeds to a “Determine Action” block 266. During block 266, process 260 determines from an examination of File_Event table 116 the type of action that occurred, e.g. a file creation, a file deletion or a file modification. If a file has been created, a value of ‘1’ has replaced a value of ‘0’ in the corresponding row of File Exists column 154. If a file has been deleted, a value of ‘0’ has replaced a value of ‘1’ in the corresponding row of File Exists column 154. If a file has been modified, the value of File Count column 156 for the corresponding row has been modified to indicate a new version of the particular, modified file has been created.

During a “File Created?” block 268, process 260 determines whether the action that caused the trigger during block 264 and was determined, during block 266, to be a file creation event. If so, process 260 proceeds to a transition point A 274, with is explained in more detail below in conjunction with FIG. 6.

If the action was not a file creation event, control proceeds to a “File Updated?” block 270 during which process 260 determines whether the action that caused the trigger during block 264 and was determined, during block 266, to be a file update, or modification, event. If so, process 260 proceeds to a transition point B 276, with is explained in more detail below in conjunction with FIG. 6.

If the action was not a file update event, control proceeds to a “File Deleted?” block 272 during which process 260 determines whether the action that caused the trigger during block 264 and was determined, during block 266, to be a file deletion event. If so, process 260 proceeds to a transition point C 278, with is explained in more detail below in conjunction with FIG. 6.

If during block 272, the triggering event is determined not to be a file deletion event, process 260 proceeds to a transition point D 280, which returns control to block 264 where, as explained above, process 260 waits for the next triggering event.

Finally, process 260 is halted by means of an interrupt 282, which passes control to an “End DB Operation” block 289 in which process 260 is complete. Interrupt 282 is typically generated when the OS, browser, application, etc. of which process 260 is a part is itself halted. During nominal operation, process 260 continuously loops through the blocks 264, 266, 268, 270 and 272; the transition points 274, 276 and 278; and the various processing associated with transition points processing 274, 276 and 278 handling data source as they are available.

FIG. 6 is an illustration of three process associated with DB Operation process 260 of FIG. 5. Shown are a “File Creation” process 300, a “File Update” process 310 and a “File Deletion” process 320. Processes 300, 310 and 320 are executed based upon the type of triggering event as determined in Determine Action block 266 (FIG. 5).

Process 300 is executed via transition point A 274 (FIG. 5). A “Process File Creation” block 302 includes code that would be executed in the event of a file creation trigger. It should be understood that triggers may be “before” or “after” triggers. A before trigger is executed before the corresponding action is executed and an after trigger is executed after the corresponding action is executed. In addition, some events may be associated with both before and after triggers.

It is expected that a database programmer, after a determination of the specific needs of the associated organization, would customize block 302 to fit those needs. The following is a simple sample of code that might be associated with block 302:

CREATE TRIGGER fileCreated
AFTER UPDATE OF fileExists ON FileEvents
REFERENCING NEW AS N
FOR EACH ROW MODE DB2SQL
WHEN (N.fileExists = 1)
SIGNAL SQLSTATE ‘90001’ SET MESSAGE_TEXT = ‘File
Created’

The code above merely sends a SQL error message upon receipt of a file creation trigger. Process 300 returns control to process 260 via transition point D 280.

Process 310 is executed via transition point B 276 (FIG. 5). A “Process File Update” block 312 includes code that would be executed in the event of a file modification trigger. The following is a simple sample of code that might be associated with block 312:

CREATE TRIGGER fileUpdated
AFTER UPDATE OF fileUpdateCount ON FileEvents
REFERENCING NEW AS N
FOR EACH ROW MODE DB2SQL
WHEN (N.fileUpdateCount > 0)
SIGNAL SQLSTATE ‘90003’ SET MESSAGE_TEXT = ‘File
Updated’

The code above merely sends a SQL error message upon receipt of a file update trigger. Process 310 returns control to process 260 via transition point D 280.

Process 320 is executed via transition point C 278 (FIG. 5). A “Process File Deletion” block 322 includes code that would be executed in the event of a file deletion trigger. The following is a simple sample of code that might be associated with block 322:

CREATE TRIGGER fileDeleted
AFTER UPDATE OF fileExists ON FileEvents
REFERENCING NEW AS N
FOR EACH ROW MODE DB2SQL
WHEN (N.fileExists = 0)
SIGNAL SQLSTATE ‘90002’ SET MESSAGE_TEXT = ‘File
Deleted’

The code above merely sends a SQL error message upon receipt of a file deletion trigger. Process 320 returns control to process 260 via transition point D 280.

Although the claimed subject matter is described with respect to the update, creation and deletion of files on a single computer, the system can be extended to include files on other systems, e.g. file_D 138 (FIG. 1) and file_E 140 (FIG. 1). If File_Events table 116 is remotely mounted on server 132, the OS of server 132 is configured properly and there are appropriate entries for files 138 and/or 140 in File_Events table 116, then RDBMS 112 can handle updates, deletions and creations of files 138 and 140 as though they were on computer 102.

In addition, updates to particular files may be detected by keeping track of file sizes of monitored files and periodically comparing file sizes. Of course, this method has the drawback that changes to a file that did not result in a change of file size would go undetected. Another method of detecting file changes is to periodically monitor file timestamps. However, timestamps may change even though a file has not. In the alternative, hash values could be maintained for registered files and recomputed periodically to check for changes.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for integrating file system events into a database management system (DBMS), comprising:
designating a file of interest;
detecting a file state change event associated with the file of interest;
updating a file events table of a database upon a detection of the file state change event;
generating a database trigger upon a change in the file events table; and
updating the database with data from the file of interest upon receipt of the database trigger.

2. The method of claim 1, the updating of the file events table comprises generating a callback upon the correlation of the file state change event to the file of interest, wherein the callback executes a structured query language (SQL) statement to effect the update to the file events table.

3. The method of claim 1, wherein the DBMS is a relational database management system (RDBMS).

4. The method of claim 1, wherein the change in the file events table is one of an insert operation, an update operation or a delete operation.

5. The method of claim 1, wherein the file state change event corresponds to a one of a file creation, a file deletion or a file update.

6. The method of claim 1, the detection of the file state change event comprising:
periodically executing a fileExists process with respect to the file of interest;
comparing a current return value from the fileExists process with a previous return value form a previous execution of the fileExists process with respect to the file of interest; and
updating the file events table when the current return value is not equal to the previous return value.

7. The method of claim 1, wherein the file state change event is generated by an operating system.

8. A system for integrating file system events into a database management system (DBMS), comprising:
a database;
a file events table associated with the database;
a file of interest;
logic for detecting a file state change event associated with the file of interest;
logic for updating the file events table upon a detection of the file state change event;
a database trigger generated upon a change in the file events table; and
logic for updating the database with data from the file of interest upon receipt of the database trigger.

9. The system of claim 8, the logic for updating of the file events table comprises logic for generating a callback upon the detection of the file state change event, wherein the callback executes a structured query language (SQL) statement to effect the update to the file events table.

10. The system of claim 8, wherein the DBMS is a relational database management system (RDBMS).

11. The system of claim 8, wherein the change in the file events table is one of an insert operation, an update operation or a delete operation.

12. The system of claim 1, wherein the file state change event corresponds to a one of a file creation, a file deletion or a file update.

13. The system of claim 8, the logic for detecting the file state change event comprising:
logic for periodically executing a fileExists process with respect to the file of interest;
logic for comparing a current return value from the fileExists process with a previous return value form a previous execution of the fileExists process with respect to the file of interest; and
logic for updating the file events table when the current return value is not equal to the previous return value.

14. The system of claim 8, wherein the file state change event is generated by an operating system.

15. A computer programming product for integrating file system events into a database management system (DBMS), comprising:
a memory;
logic, stored on the memory, for designating a file of interest;
logic, stored on the memory, for detecting a file state change event associated with the file of interest;
logic, stored on the memory, for updating a file events table of a database upon a detection of the file state change event;
logic, stored on the memory, for generating a database trigger upon a change in the file events table; and
logic, stored on the memory, for updating the database with data from the file of interest upon receipt of the database trigger.

16. The computer programming product of claim 15, the logic for updating of the file events table comprises logic for generating a callback upon the correlation of the file state change event to the file of interest, wherein the callback executes a structured query language (SQL) statement to effect the update to the file events table.

17. The computer programming product of claim 15, wherein the DBMS is a relational database management system (RDBMS).

18. The computer programming product of claim 15, wherein the change in the file events table is one of an insert operation, an update operation or a delete operation.

19. The computer programming product of claim 15, wherein the file state change event corresponds to a one of a file creation, a file deletion or a file update.

20. The computer programming product of claim 15, the logic for detecting the file state change event comprising:
logic for periodically executing a fileExists process with respect to the file of interest;
logic for comparing a current return value from the fileExists process with a previous return value form a previous execution of the fileExists process with respect to the file of interest; and
logic for updating the file events table when the current return value is not equal to the previous return value.
